(19) United States
(12) Patent Application Publication
(10) Pub. No.: US 2026/0284684 A1
(43) Pub. Date: Sep. 24, 2026

(54) PRESSURE WASHER AND METHOD FOR OPERATING A PRESSURE WASHER

(71) Applicant: Andreas Stihl AG & Co. KG, Waiblingen (DE)

(72) Inventors: Simon Nadler, Stuttgart (DE); Rainer Grohmann, Ludwigsburg (DE); Stefan Bassmann, Backnang (DE)

(21) Appl. No.: 19/570,715

(22) Filed: Mar. 18, 2026

(30) Foreign Application Priority Data
Mar. 18, 2025 (DE) 10 2025 110 475.1

(51) Int. Cl. B05B 12/14; B05B 7/04; B05B 9/04

(52) U.S. Cl. CPC B05B 12/1418; B05B 7/0408; B05B 9/0403

(57) ABSTRACT

The pressure washer includes a pump unit with a high-pressure pump and with a control unit. It further includes a sprayer unit with a transmitting unit and with an operator-controlled element. The pump unit and the sprayer unit are fluidically interconnected via a main line. The transmitting unit is configured to establish a radio link and to transmit a control signal generated by the operator-controlled element to the control unit. The control unit is configured to influence at least one operating parameter of the pump unit on the basis of the transmitted control signal. The control unit checks, when the pressure washer is being switched on, whether the radio link is correctly established. When the radio link is absent or disrupted, at least the operating parameter to be influenced by the control signal assumes a fixed preset value. A method is for operating the pressure washer.

### CROSS-REFERENCE TO RELATED APPLICATIONS

This application claims priority of German patent application no. 10 2025 110 475.1, filed Mar. 18, 2025, the entire content of which is incorporated herein by reference.

### BACKGROUND

Pressure washers are known in a wide variety of configurations and are intended for cleaning objects via a pressurized cleaning liquid. The cleaning liquid used is in particular water, which can also be mixed with an additive as and when required. Such pressure washers include a pump unit, which for its part includes a high-pressure pump for delivering the cleaning liquid and a control unit. The pressure washer further includes a for example pistol-like sprayer unit which has an operator-controlled element, the pump unit and the sprayer unit being fluidically connected to one another via a main line.

In certain embodiments, the pressure washer can be provided with a transmitting unit. The transmitting unit establishes a radio link and transmits a control signal generated by the operator-controlled element to the control unit. The control unit is configured to influence at least one operating parameter of the pump unit on the basis of the transmitted control signal. A pressure washer of this kind is known for example from US 2024/0342761 A1. A sprayer unit is in the form of a high-pressure pistol and includes an actuating element and a battery-powered communication element for establishing a radio link. Pressing on the actuating element causes a corresponding control signal to be transmitted by radio from the high-pressure pistol to a receiving unit, in order to make the device ready for operation or stop it being ready for operation, or to switch it off, via its control unit as desired. During operation, test signals are used to ascertain whether the radio transmission is functioning correctly. In the event of disruption, the control unit waits for a defined period of time to pass or for a predefined number of test signals to go unanswered before it interrupts the supply of electrical power, as a result of which the device is switched off.

In this case, the operating state after the device is switched on again is problematic and unexplained. Previously, certain operating parameters such as the setting of an operating pressure or the admixture of a chemical cleaning agent were set via radio. When the device is forcibly switched off owing to a fault, the device has the same operating parameters as were previously set. If the correct function of the radio link cannot be restored, a restart of the device can lead to retention of or undesired changes to the operating parameters, which then cannot be corrected owing to the absence of the radio link.

### SUMMARY

It is an object of the disclosure to further develop a pressure washer such that it is possible to switch it on with increased operational reliability.

This object is, for example, achieved by a pressure washer for cleaning objects via a pressurized cleaning liquid, the pressure washer including: a pump unit having a high-pressure pump for delivering the pressurized cleaning liquid and a control unit; a sprayer unit having a transmitting unit and an operator-controlled element; a main line; the pump unit and the sprayer unit being fluidically connected to one another via the main line; the transmitting unit being configured to establish a radio link and to transmit a control signal generated by the operator-controlled element to the control unit; the control unit being configured to influence an operating parameter of the pump unit on a basis of the transmitted control signal; the control unit being further configured to check, when the pressure washer is being switched on, whether the radio link has been correctly established; and, wherein, when the radio link is absent or disrupted, at least the operating parameter to be influenced by the control signal assumes a fixed preset value.

The above object is, for example, also achieved by a method for operating a pressure washer for cleaning objects via a pressurized cleaning fluid, wherein the pressure washer includes a pump unit having a high-pressure pump for delivering the pressurized cleaning liquid and a control unit, the pressure washer further including a sprayer unit having a transmitting unit and an operator controlled element, the pump unit and the sprayer unit being fluidically connected to one another via a main line, the transmitting unit being configured to establish a radio link and to transmit a control signal generated by the operator-controlled element to the control unit, and the control unit being configured to influence at least one operating parameter of the pump unit on a basis of the transmitted control signal, the method including: checking via the control unit, when the pressure washer is being switched on, whether the radio link is established correctly; and, when the radio link is absent or disrupted, setting the at least one operating parameter to be influenced by the control signal to a fixed preset value via the control unit.

According to the disclosure, it is provided that, when the pressure washer is being switched on, the control unit checks whether the radio link is established correctly, and that, when the radio link is absent or faulty, the control unit sets at least the operating parameter to be influenced by the control signal to a fixed preset value. “Switching on” is considered here to be the starting up, via a main switch, and/or the beginning of the cleaning operation by actuation of an operating device or an operator-controlled element on the sprayer unit. This avoids the relevant operating parameter assuming an undesired value. Such an operating parameter is in particular an achievable delivery output of the pump unit and/or in particular an amount of additive to be admixed with the cleaning liquid by an admixing device. It is not possible for the relevant operating parameter to be inadvertently transferred from the previous mode, or for it to be set undesirably and independently to an undefined value. Rather, a fixed, preset and defined state is brought about which allows a manual mode of the pressure washer even without a radio link. In this way, the device can be used again until for example a replacement battery is provided for a transmitting unit or the source of radio disruption can be eliminated.

It can be expedient to set the achievable delivery output to a low or medium value in the event of a fault. In particular, it is provided that the achievable delivery output of the pump unit is set to a maximum value. This allows the full cleaning power to be brought to bear even in manual mode.

In particular, it is provided that a bypass line with a bypass valve that can be activated by the control unit is connected fluidically in parallel with the high-pressure pump, and that the achievable delivery output is set via the bypass valve. As an alternative, the high-pressure pump can be driven via a motor, the achievable delivery output being set via the speed of the motor.

If the pump unit includes an admixing device for an additive and the control unit is configured to influence an amount of additive admixed with the cleaning liquid by the admixing device as operating parameter, the admixing device assumes in particular a closed state as fixed preset value when an absent or disrupted radio link is detected. This allows the pressure washer to be operated with basic functions alone in manual mode without an additive undesirably being dispensed at unsuitable locations.

In particular, the control unit is configured and is also operated such that, even when a correctly working radio link is subsequently established, the at least one operating parameter has the same fixed preset value until the pressure washer is switched off. This avoids a surprising, unexpected change in the one or more operating parameters during operation.

In particular, the control unit is configured and is also operated such that, during operation, it is checked that a correctly working radio link is present and that, when the correctly working radio link is disrupted or interrupted, a fault signal perceptible to the user is generated. This avoids the user being surprised by unexpected changes in state of the one or more operating parameters. In particular, the control unit is configured and is also operated such that it prompts the user to acknowledge the fault signal. In this way, it is ensured that the user has actually perceived the fault state of the radio link.

The fault signal can be a light signal or an audible signal. The acknowledgement can be given by actuating a button or a switch. In particular, the control unit is configured and is also operated such that it switches off the pressure washer as fault signal and that it makes it necessary to switch the pressure washer back on to acknowledge the fault signal. Without additional display and operator-controlled elements, the user is clearly made aware of the state of the radio link. The switching back on automatically leads to the desired procedure, and therefore either a control mode is adopted in the event of a fault being eliminated and the radio link being restored, or at least a safer manual mode can be implemented when there is persistent disruption to the radio link.

### BRIEF DESCRIPTION OF DRAWINGS

The invention will now be described with reference to the drawings wherein:

FIG. 1 shows a perspective illustration of a pump unit of a pressure washer;

FIG. 2 shows perspective illustrations of a handheld sprayer unit of the pressure washer;

FIG. 3 shows a schematic illustration of a pressure washer with a radio link between the pump unit and the sprayer unit and with a volume flow setting device in the form of a bypass line with a bypass valve and a servomotor for the bypass valve; and,

FIG. 4 shows a variant of the arrangement according to FIG. 3 with a volume flow setting device in the form of a high-pressure pump and a motor for driving the latter.

### DETAILED DESCRIPTION

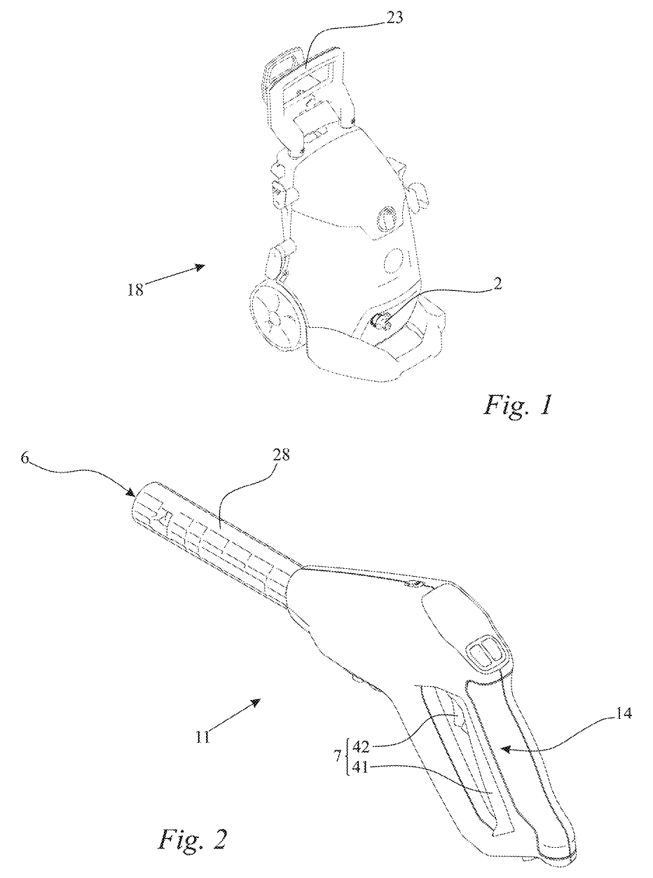

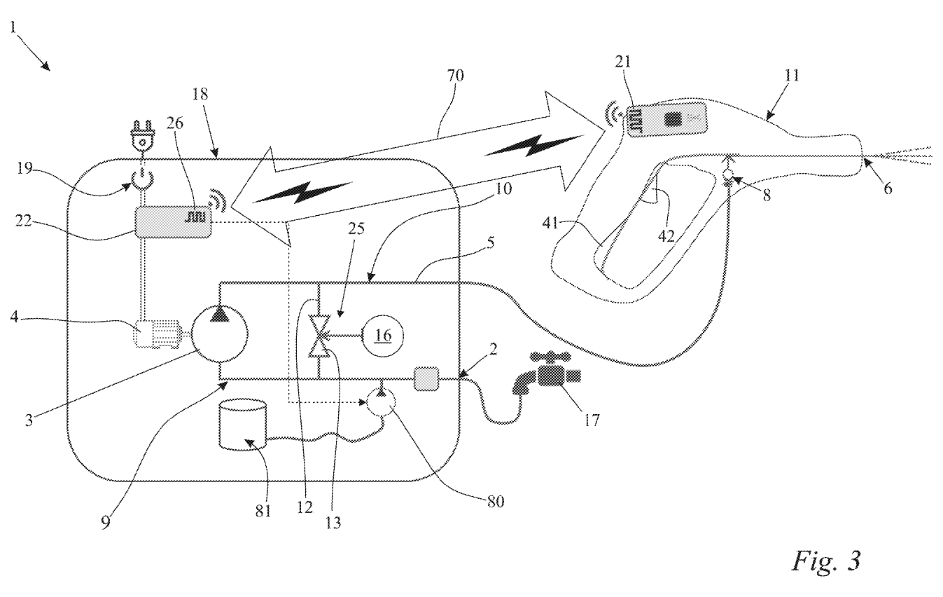

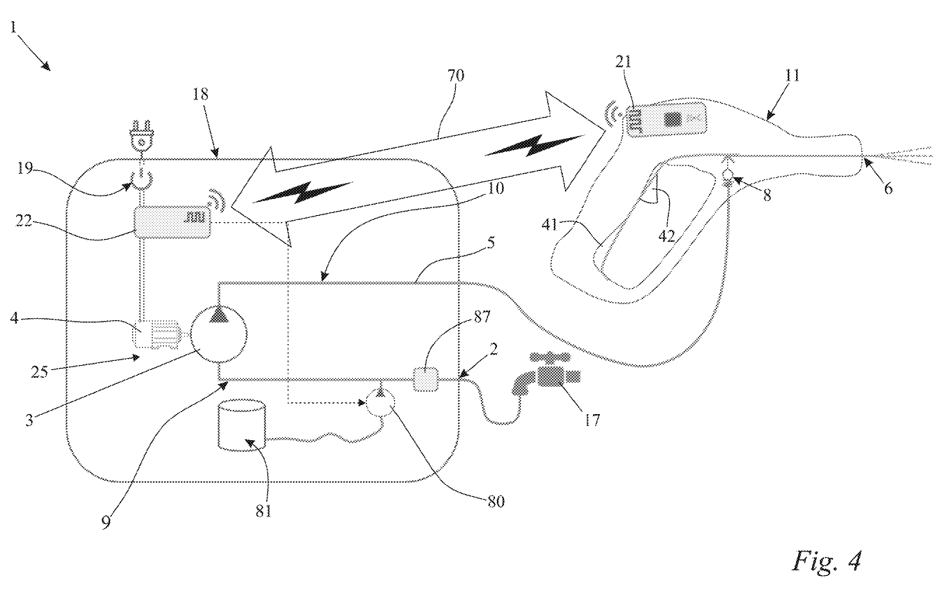

FIG. 1 shows a pump unit 18 of a pressure washer 1 illustrated schematically in FIG. 3. According to the alternative embodiment, the pump unit 18 can also be configured as per FIG. 4.

In both embodiments of the pressure washer 1, the pressure washer 1 also includes, in addition to the pump unit 18, a sprayer unit 11. The sprayer unit 11 can be in the form of a pistol as schematically illustrated in FIGS. 3 or 4. A spray discharge opening 6 is arranged on the pistol. As an alternative, the sprayer unit 11 can be in the form of a pistol with a lance 28, as indicated in FIG. 2. In this case, the spray discharge opening 6 is arranged on the lance 28.

In all embodiments, the volume flow of liquid in a main line 5 can be influenced, in particular varied, in particular set by a volume flow setting device 25. The embodiments according to FIGS. 3 and 4 differ in the configuration of the volume flow setting device 25.

Therefore, four different embodiments in total are illustrated in the drawing. Unless explicitly stated otherwise, the description below relates to all the embodiments – even when the corresponding features are described only in connection with one of the figures.

The pressure washer 1, in particular the sprayer unit 11, is configured to clean objects via a pressurized cleaning liquid. In the embodiments, the pressure washer 1 is portable. The pressure washer 1 has a handle 23, which is illustrated in FIG. 1. The pressure washer 1, in particular the pump unit 18 of the pressure washer 1, is portable by the handle 23. During operation as intended, it is provided that the pressure washer 1, in particular the pump unit 18, is turned off.

As illustrated in FIGS. 3 or 4, the pressure washer 1 has a high-pressure pump 3. The high-pressure pump 3 is part of the pump unit 18. Via the high-pressure pump 3, the liquid, namely the aforementioned cleaning liquid, in the pressure washer 1, in particular in the pump unit 18, can be pressurized. In particular, the cleaning liquid is water, in particular a mixture of water and an additive. The additive is in particular a cleaning agent solution, in particular a soap solution. In particular, the cleaning agent is in the liquid state. The high-pressure pump 3 can pressurize the liquid to a pressure of at least 10 bar, in particular at least 15 bar, in particular at least 30 bar, in particular at least 100 bar. In particular, the high-pressure pump 3 can pressurize the liquid at most to a pressure of no more than 600 bar, in particular no more than 500 bar. The high-pressure pump 3 includes at least one piston (not illustrated). The at least one piston can be moved back and forth to pressurize the liquid. Typically, the high-pressure pump 3 includes three pistons.

As illustrated in FIGS. 1 and 3 or 4 , the pressure washer 1 includes a connection 2 for a source of liquid 17. Here, the connection 2 is arranged on the pump unit 18. In the embodiments, the source of liquid 17 is an external source of liquid. In the embodiments, the external source of liquid is a faucet of a domestic water supply system. It can also be provided that the source of liquid is an integral part of the pressure washer 1. The pressure washer 1 includes a main line 5. As illustrated in FIGS. 3 or 4 , the pump unit 18 and the sprayer unit 11 are fluidically connected to one another via this main line 5 in all embodiments. The main line 5 fluidically connects the connection 2 to the spray discharge opening 6.

Via the high-pressure pump 3, liquid can be delivered from the connection 2 to the spray discharge opening 6 through the main line 5. The source of liquid 17 feeds liquid to the main line 5. The high-pressure pump 3 is arranged in the main line 5. The high-pressure pump 3 pressurizes the liquid. The high-pressure pump 3 is arranged between a suction chamber 9 and a pressure chamber 10 of the main line 5. In the embodiments, the suction chamber 9 is formed by a portion of the main line 5 between the connection 2 and the high-pressure pump 3. In the embodiments, the pressure chamber 10 is formed by a portion of the main line 5 between the high-pressure pump 3 and the spray discharge opening 6. The high-pressure pump 3 delivers liquid from the suction chamber 9 to the pressure chamber 10. During operation, a greater pressure prevails in the pressure chamber 10 than in the suction chamber 9.

To drive the high-pressure pump 3, the pressure washer 1 has a motor 4. The motor 4 is arranged in the pump unit 18. The motor 4 can be in the form of a brushless DC motor. A brushless DC motor is also referred to as an EC motor. The motor can also be a universal motor. In the embodiments, the motor 4 is an induction motor. In an induction motor, a magnetic field around the stator sets the rotor in motion. In the embodiments, the induction motor is operated with AC voltage. The voltage source can be provided for example by the mains voltage. If a battery or rechargeable battery drive is provided, the motor can also be a brushless DC motor. It can then be provided that the rechargeable battery is part of the pressure washer 1.

As illustrated in FIGS. 3 or 4, the pressure washer 1 includes a main switch 19. The main switch 19 serves to interrupt the electrical voltage supply of the entire pressure washer 1. The main switch 19 is arranged on the pump unit 18.

The pressure washer 1 includes a main line valve 8. The main line valve 8 is arranged in the main line 5. In the embodiments, the main line valve 8 is arranged in the sprayer unit 11. The main line valve 8 has a closed state and a fully open state. In the fully open state, the main line valve 8 allows the cleaning liquid to flow through the main line 5. In the fully open state, that cross section of flow of the main line 5 that is located at the position of the main line valve 8 is at its greatest. In the closed state, the main line valve 8 prevents the cleaning liquid from flowing through the main line 5, in particular completely. In the fully open state of the main line valve 8, the cleaning liquid is sprayed out of the spray discharge opening 6 during operation of the pressure washer 1. In the closed state of the main line valve 8, no liquid is sprayed out of the spray discharge opening 6. In the embodiments, the main line valve 8 is arranged between the high-pressure pump 3 and the spray discharge opening 6. It can, however, also be provided that the main line valve 8 is arranged in the pump unit 18. It can also be provided that the main line valve 8 is arranged between the connection 17 and the high-pressure pump 3.

The pressure washer 1 includes the volume flow setting device 25 illustrated in FIG. 3 or in an alternative configuration in FIG. 4. Via the volume flow setting device 25, the pressure in the main line 5, in particular in the pressure chamber 10, can be influenced, in particular varied, in particular set.

The pressure washer 1, in particular the sprayer unit 11, has an operating device 7. In the embodiments, the operating device 7 is arranged on the sprayer unit 11. The operating device 7 is provided separately from the main switch 19.

In the embodiments, the operating device 7 includes a first operator-controlled element 41 and a second operator-controlled element 42. The first valve operator-controlled element 41 serves to actuate the main line valve 8, in particular to switch it between the closed state and the fully open state. The second operator-controlled element 42 serves to influence at least one operating parameter of the pump unit 18 via a control signal, which will be explained in greater detail later on. In the present case, the operating parameter by way of example is two operating parameters, namely on the one hand a delivery output achievable by the pump unit 18 and/or on the other hand an amount of an additive 81 to be admixed with the cleaning liquid via an admixing device 80, which is described later on. Within the context of the disclosure, further operator-controlled elements and/or further operating parameters influenced by an associated operator-controlled element can be considered.

In the present case, the second operator-controlled element serves to actuate the volume flow setting device 25 for influencing the achievable delivery output, and to actuate the optional admixing device 80 described later on for influencing the amount of additive 81 admixed with the cleaning liquid. As an alternative to the embodiments, it can also be provided that the operating device 7 consists of a single operator-controlled element which serves both to actuate the main line valve 8 and to influence the operating parameters.

For the volume flow setting device 25, FIG. 3 illustrates a first embodiment and FIG. 4 illustrates a second embodiment.

In the embodiment according to FIG. 3, the pressure washer 1, in particular the pump unit 18, has a bypass line 12 with a bypass valve 13. The bypass valve 13 can be adjusted via a servomotor 16. Here, the volume flow setting device 25 includes the bypass line 12, the bypass valve 13 and the servomotor 16.

There is a fluidic connection between the suction chamber 9 and the pressure chamber 10 via the high-pressure pump 3. Separately from this, the pressure chamber 10 can be fluidically connected to the suction chamber 9 through the bypass line 12 by opening the bypass valve 13 in a parallel connection configuration with respect to the high-pressure pump 3. When the high-pressure pump 3 is operating, a greater pressure prevails in the pressure chamber 10 than in the suction chamber 9. Owing to this pressure gradient, liquid can flow from the pressure chamber 10 into the suction chamber 9 through the bypass line 12. Via the bypass valve 13, a free cross-sectional area of the bypass line 12 can be set. This allows the pressure in the pressure chamber 10 to be regulated. The bypass valve 13 can be adjusted in stages or infinitely variably between a fully closed state and a fully open state. Here, the operator-controlled element 42 serves to prescribe, in particular to set, an open state of the bypass valve 13. Via the servomotor 16, the open state of the bypass valve 13 can be adjusted in such a way that the free cross-sectional area of the bypass line 12 and thus the achievable delivery output in the pressure chamber 10 can be varied, in particular set. The smaller the free cross-sectional area of the bypass valve 13 in the bypass line 12, the greater the achievable delivery output in the pressure chamber 10, and the greater the liquid volume flow when the main line valve 8 is open.

In the embodiment according to FIG. 4, the achievable delivery output in the main line 5, in particular in the pressure chamber 10, is varied, in particular set, via an alternative volume flow setting device 25. By contrast to the embodiment according to FIG. 3, in the embodiment according to FIG. 4 no bypass line is provided. Rather, here the volume flow setting device 25 includes the motor 4 and the high-pressure pump 3. For the influencing, in particular the variation, in particular the adaptation, in particular the setting of the achievable delivery output in the main line 5, in particular in the pressure chamber 10, in the embodiment according to FIG. 4 the speed of the motor 4 for driving the high-pressure pump 3 can be varied. In this case, the operator-controlled element 42 serves to prescribe, in particular to set, a speed of the motor 4. The greater the speed of the motor 4, the greater the achievable delivery output in the pressure chamber 10, and the greater the liquid volume flow when the main line valve 8 is open.

In all embodiments, the pressure washer 1 further includes an optional admixing device 80 which is illustrated in FIGS. 3 and 4. The admixing device 80 serves to admix an additive 81 with the liquid. In the embodiments, the additive 81 is a cleaning agent solution. In the embodiments, the pressure washer 1 is configured such that the additive 81 can be fed to the main line 5, in particular upstream of the high-pressure pump 3 in the suction chamber 9, by the admixing device 80. It can, however, also be provided that the admixing device 80 introduces the additive 81 downstream of the high-pressure pump 3, directly into the pressure chamber 10.

In the embodiments, the admixing device 80 is an additional pump. The additional pump is provided separately from the high-pressure pump 3. The additional pump pressurizes the additive 81 by itself, independently of the high-pressure pump 3.

The pressure washer 1 is configured in such a way that the additive volume flow can be influenced, in particular varied, in particular set via the second operator-controlled element 42. In particular, the magnitude of the additive volume flow depends on the degree to which the operator-controlled element 42 is actuated.

In all embodiments, the second operator-controlled element 42 of the sprayer unit 11 generates a control signal which depends on an actuation of the second operator-controlled element 42, in particular a degree to which the latter is actuated, and via which the one or more aforementioned operating parameters of the pump unit 18 are influenced. Multiple second operator-controlled elements and/or multiple control signals may also be expedient. To transmit the at least one control signal from the sprayer unit 11 to the pump unit 18, a radio link 70 is established between the sprayer unit 11 and the pump unit 18. For this purpose, the sprayer unit 11 includes a transmitting unit 21, and the pump unit 18, in particular the control unit 22 of the pump unit 18, includes an associated receiving unit 26. The transmitting unit 21 can in particular include a battery for supplying it with voltage. During operation, the at least one control signal is transmitted by the transmitting unit 21 to the receiving unit 26 via the radio link 70 and fed into the control unit 22. In particular, this offers the possibility that the transmitting unit 21 and the receiving unit 26 are both in the form of combined transceiver units, so that a bidirectional radio link 70 is established between both.

The control unit 22 for its part acts on the corresponding components of the pump unit 18. In all embodiments, for this purpose there is an operative connection between the control unit 22 and the respective volume flow setting device 25 for influencing of the achievable delivery output, and also between the control unit and the admixing device 80 for influencing of the amount of additive 81 to be admixed with the cleaning liquid. As a result, the volume flow setting device 25 sets the delivery output achievable with the high-pressure pump 3 in the main line 5, in particular in the pressure chamber 10, on the basis of the control signal transmitted via the radio link 70. Similarly, the admixing device 80 sets the amount of additive 81 to be admixed with the cleaning liquid on the basis of the control signal transmitted via the radio link 70.

The operating mode described above with correctly working radio transmission of the control signal and with influencing of the corresponding operating parameter is also referred to as “control mode”. It is, however, checked whether such a “control mode” is possible at all. According to the disclosure, the control unit 22 is configured and is also operated such that, when the pressure washer 1 is being switched on, it checks whether the radio link 70 is established correctly. “Switching on” is considered here to be the starting up, via the main switch 19, and/or the beginning of the cleaning operation by actuation of the operating device 7, in particular the second operator-controlled element 42, on the sprayer unit 11. If there is a defect, if the battery of the transmitting unit 21 is empty, or if there are external radio disruptions or other startups, the radio transmission can be disrupted or even completely absent. When in such a case the pressure washer, in particular the control unit 22, establishes that the radio link 70 is disrupted or even not established at all, that is, is absent, then the control unit 22 causes at least the operating parameter to be influenced by the control signal to assume a fixed preset value. The control mode is therefore not permitted at all at the very beginning. Rather, the one or more operating parameters are set to a desired, non-critical value, as a result of which at least a manual mode is possible in a further operating mode even without the control mode.

As described above, in the present case one of the operating parameters to be influenced on the basis of the transmitted control signal is the delivery output of the pump unit 18. In the embodiments shown, if the radio link 70 is disrupted or is not established at all and thus is absent when the pressure washer 1 is being switched on, the achievable delivery output is set to a maximum value via the volume flow setting device 25. In the same case, the admixing device 80 is set to a closed state as fixed preset value and thus the amount of additive 81 to be admixed is set to zero.

In all embodiments, the control unit 22 is additionally configured and is also operated such that, even if a correctly working radio link 70 is subsequently established, the at least one operating parameter has the same fixed preset value until the pressure washer 1 is switched off. The resumption of the control mode is therefore only possible after switching the pressure washer 1 back on and when the radio link 70 has been correctly established.

In all embodiments, according to a further aspect the control unit 22 is configured and is also operated such that it checks not only during switching on but also during operation that a correctly working radio link 70 is present. When the correctly working radio link 70 is disrupted or interrupted during operation, a fault signal perceptible to the user is generated. This fault signal can be an acoustically and/or optically perceptible signal. In particular, a configuration and a mode of the control unit are provided to require the user to acknowledge the fault signal. The acknowledgement can be given for example by pressing a button or the like. In particular, the control unit 22 is configured and is also operated such that it switches off the pressure washer 1 as fault signal and that it makes it necessary to switch the pressure washer 1 back on to acknowledge the fault signal. If, when switching back on, there is still no correctly working radio link 70, the pressure washer 1 as described above can be used at least in manual mode, until the cause of the malfunction of the radio link 70 has been found and eliminated.

It is understood that the foregoing description is that of the preferred embodiments of the invention and that various changes and modifications may be made thereto without departing from the spirit and scope of the invention as defined in the appended claims.

1. A pressure washer for cleaning objects via a pressurized cleaning liquid, the pressure washer comprising:
a pump unit having a high-pressure pump for delivering the pressurized cleaning liquid and a control unit;
a sprayer unit having a transmitting unit and an operator-controlled element;
a main line;
said pump unit and said sprayer unit being fluidically connected to one another via said main line;
said transmitting unit being configured to establish a radio link and to transmit a control signal generated by said operator-controlled element to said control unit;
said control unit being configured to influence an operating parameter of said pump unit on a basis of the transmitted control signal; and,
said control unit being further configured to check, when the pressure washer is being switched on, whether the radio link has been correctly established; and,
wherein, when the radio link is absent or disrupted, at least the operating parameter to be influenced by the control signal assumes a fixed preset value.

2. The pressure washer of claim 1, wherein the operating parameter to be influenced by the control signal is an achievable delivery output of said pump unit.

3. The pressure washer of claim 2, wherein the achievable delivery output is set to a maximum value.

4. The pressure washer of claim 2 further comprising:
a bypass line having a bypass valve configured to be activated by said control unit being fluidically connected in parallel with said high-pressure pump; and,
the achievable delivery output is set via said bypass valve.

5. The pressure washer of claim 2, wherein said high-pressure pump is configured to be driven via a motor; and, the achievable delivery output is set via a speed of said motor.

6. The pressure washer of claim 1, wherein said pump unit includes an admixing device for an additive; said control unit is configured to influence an amount of the additive to be admixed with the pressurized cleaning liquid by said admixing device as theoperating parameter; and, when the radio link is absent or disrupted, said admixing device assumes a closed state as the fixed preset value.

7. The pressure washer of claim 1, wherein the control unit is configured such that the operating parameter has the same fixed preset value until the pressure washer is switched off, even when a correctly working radio link is subsequently established.

8. The pressure washer of claim 1, wherein said control unit is configured such that, during operation, it is checked that a correctly working radio link is present; and, when the correctly working radio link is disrupted or interrupted, a fault signal perceptible to an operator is generated.

9. The pressure washer of claim 8, wherein said control unit is configured to prompt the operator to acknowledge the fault signal.

10. The pressure washer of claim 9, wherein said control unit is configured to switch off the pressure washer as a result of the fault signal; and, wherein it is necessary to switch the pressure washer back on to acknowledge the fault signal.

11. A method for operating a pressure washer for cleaning objects via a pressurized cleaning fluid, wherein the pressure washer includes a pump unit having a high-pressure pump for delivering the pressurized cleaning liquid and a control unit, the pressure washer further including a sprayer unit having a transmitting unit and an operator controlled element, the pump unit and the sprayer unit being fluidically connected to one another via a main line, the transmitting unit being configured to establish a radio link and to transmit a control signal generated by the operator-controlled element to the control unit, and the control unit being configured to influence at least one operating parameter of the pump unit on a basis of the transmitted control signal, the method comprising:
checking via the control unit, when the pressure washer is being switched on, whether the radio link is established correctly; and,
when the radio link is absent or disrupted, setting the at least one operating parameter to be influenced by the control signal to a fixed preset value via the control unit.
